(19) United States
(12) Patent Application Publication
(10) Pub. No.: US 2010/0213897 A1
(43) Pub. Date: Aug. 26, 2010

(54) Battery-Cell Converter Management Systems

(76) Inventor: Lawrence Tze-Leung Tse, Fremont, CA (US)

Correspondence Address: Lawrence Tze-Leung Tse, 46917 Zapotec Drive, Fremont, CA, 94539, US

(21) Appl. No.: 12/709,459

(22) Filed: Feb. 20, 2010

Related U.S. Application Data
(60) Provisional application No. 61/208,304, filed on Feb. 23, 2009.

(51) Int. Cl. H02J 7/00

(52) U.S. Cl. 320/116; 320/126; 320/142

(57) ABSTRACT

A battery cell converter (BCC) unit including one or more energy-storing battery cells coupled to one or more DC/DC converters is disclosed. A management unit can monitor and control the charging and discharging of each battery cells; including monitoring of voltages & State-of-Charge of each cell as well as controlling the switching of the DC/DC converters. The combined power and cell switching algorithms optimizes the charging and discharging process of the battery cells. A compound battery cell converter system comprising a series stack of BCCs to achieve high effective converter output voltage is also disclosed. The new proposed Battery Cell Converter architecture will enable improvements in battery pack usage efficiencies, will increase battery pack useable time per charge, will extend battery pack life-time and will lower battery pack manufacturing cost.

### CROSS-REFERENCE TO RELATED APPLICATIONS

This application claims priority to provisional U.S. application Ser. No. 61/208,304, filed on Feb. 23, 2009, the disclosure of which is fully incorporated in its entirety by reference herein.

### BACKGROUND OF INVENTION

1. Field of Invention

The present invention generally relates to systems and methods of constructing a battery unit out of a plurality of battery cells coupled to or integrated with a plurality of voltage/current converter units for rechargeable batteries.

2. Description of Related Art

With the growing requirements of high-energy battery-operated applications, the demand of multi-cell battery packs has been increasing drastically. Multi-cell is needed to serve the high capacity/energy requirements of certain battery applications. Within a multi-cell battery pack, there is usually more than one cell connected in series. For example, a battery pack with four 1.2-volt cells connected in series gives a nominal voltage of 4.8V (FIG. 1). Other applications such as battery packs for laptop computers may have four 3.6-volt cells connected in series (FIG. 2) to provide a nominal battery pack output voltage of 14.4V. In addition, two of such 4-cell strings may be connected in parallel to increase the capacity from 2000 milli-Amp-hours (mAh) to 4000 mAh. This configuration is generally known in the industry as 4S2P, or 4-cell series 2-in-parallel. At this moment, popular multi-cell rechargeable battery packs used in handheld appliances, computers, power tools, etc, are rather expensive and range from US$30 to US$300, depending on the number of cells and their respective capacity in the pack.

A battery cell can be damaged by excessively charged to a high voltage or excessively discharged to a low voltage. This is particularly true for Lithium-ion and Lithium polymer-based batteries. The high- and low-voltage cutoffs are typically around 4.2V and 2.7V respectively. The properties of Li-ion battery are shown in FIG. 3. After the battery discharges to about 2.7-3.0V, the battery quickly dies out and can also get damaged. Therefore, it is critical to provide a rechargeable battery pack with a smart battery management system facilitating over-charge, over-discharge, and over-temperature protection and SOC (State-Of-Charge) monitoring of the battery cell in a pack. The benefit is further advantageous by the fact that over-charge or over-discharge of battery cells can lead to reduction of battery capacity, shorter battery lifetime, and even hazardous conditions such as fires and explosions.

One of the key challenges in charging/discharging multi-cell battery units is related to the non-uniformity of battery cells within the pack due to manufacturing tolerances. There is more than one type of battery cell mismatch. Referring to FIG. 4, a battery cell pack 40 includes cells 41, 42 and 43. Cell 42 has lower capacity than cells 41 and 43, which is symbolically shown by a smaller “bucket size” for cell 42 in FIG. 4. When fully charged, cell 42 will provide less charge during operation than cells 41 and 43. In a battery cell pack 400 including cells 410, 420, and 430, the cells 410 and 430 are fully charged, while cell 420 is not fully charged. Therefore, there is SOC mismatch between cells 410, 430 and cell 420.

A weakest battery cell tends to limit the overall capacity of the entire battery pack unit. Therefore, special manufacturing processes are needed to ensure tighter tolerance. One example of such special manufacturing process involves binning and grouping cells based on their capacity properties. The pack will use cells from the same bin. However, such an extra step increases manufacturing cost. Moreover, mismatch between the cells increases after charge/discharge cycles which reduces the benefit of binning at the factory. The factories that do not go through a costly binning process have the yields on their battery cells severely impacted. Besides, disposal of out-of-spec cells can increase the pollution footprint of the manufacturing facility.

It is apparent that this binning step is a brute-force approach and can only partially mitigate cell mismatch issue since cell mismatches tend to get worse after multiple charge/discharge cycles. As a result, mismatch degradations cannot be easily addressed during battery cell manufacturing and quality control.

In addition, a battery pack that includes a series of stacked battery cells will no longer be functional if any given cell in the stack is severely degraded, such as the case as shown in FIG. 4a. In other words, the battery pack's life time is then cut short due to one single damaged cell.

Hence, it would be essential to have a smart battery management system that can ensure safety, extend battery life and reduce battery manufacturing cost. The Li-ion battery charging process typically uses medium accuracy constant-current (CC) charging in a first phase, transitioning to high-accuracy constant-voltage (CV) charging in a second phase. This is to allow the cell to be fully charged to the desired voltage while preventing the cell from being overcharged. Such charging control is more straightforward for a single battery cell, but is a complex task for a series string of battery cells when the cells are not well-matched. Hence, cell balancing during charging is used to ensure each of the cells will not be overcharged while allowing each cell to be charged to near its respective capacity. The concept of cell “balancing” refers to the process of monitoring and adjusting the charges stored in each of the cells in the battery pack (typically including cells connected in series in today's design), hence balancing the terminal voltage and the capacity of each of the cells within the voltage limits and managing the SOC of the cells via fuel gauging. Since the cells are not identical and do have mismatches, the process of balancing may involve purposely dissipating energy stored in certain cells that have higher terminal voltages or SOC in order to avoid cell overcharging and equalize the SOC among all cells in a given charging instance.

Alternatively, charge can be moved from more charged cells to less charged cells to equalize the SOC among cells.
A number of conventional approaches describe methods of charging battery cells, mostly focusing on uniform charging to ensure that no cell constitutes a weak cell in a multi-cell battery pack, while ignoring mismatches that occurred during discharge cycles. Some conventional approaches explore methods of transferring charge from stronger cells to weaker cells in a multi-cell battery pack, in order to mitigate the operational limitation due to weak cell. Note that practical implementation of charge transfer type of battery cell balancing is typically limited to charge transfer to a neighboring cell, it is impractical to implement a matrix of charge transfer circuits that can allow any two cells to have a charge transfer path. In addition, there are losses associated with charge balancing.

Also, many multi-cell battery packs are configured in series-parallel fashion as in FIG. 2. As an individual cell becomes defective, the whole chain of series-stacked cells cannot be used and the multi-cell battery unit capacity is immediately halved.

### BRIEF SUMMARY OF THE INVENTION

A new method of constructing a rechargeable battery unit is by exploring the advantages of the combined, integrated solution of power converters and charge-storing battery cells. This new topology improves battery per-charge use-time, battery pack life-time, and battery pack manufacturing cost by practically eliminating a) the need for special cell binning procedures during battery pack manufacturing to select better matched cells into a given battery pack, and b) the need for special cell balancing procedure during charging and/or discharging of battery packs (which also eliminates the external components such as Ls, Cs, or Rs needed for cell balancing operations). The new BCC architecture enables a multi-cell battery pack to continue to function substantially close to normal operation with the presence of badly degraded battery cells residing in the pack.

### BRIEF DESCRIPTION OF THE DRAWINGS

FIG. 1 Conventional multi-cell battery arrangement stacking the cells in series configuration

FIG. 2 Conventional multi-cell battery with series-parallel arrangement (stacking the cells in series, and arranging the stacks in parallel)

FIG. 3 Properties of Lithium Ion Battery Cell

FIG. 4 Mismatches of Battery Cells

FIG. 4a Degraded battery cell limits battery pack life-time

FIG. 5a Battery Cell Converter Block Diagram

FIG. 5 One of the proposed multi-cell Battery-Cell Converter configurations

FIG. 6a, b, c Examples of buck/boost, buck, and boost DC/DC converters to be used in a Battery Cell Converter

FIG. 7 An example of a Battery Cell Converter using two cells and a DC/DC converter with shared components

FIG. 8 Simplified schematics of a 2-cell Battery Cell Converter with parallel battery cells

FIG. 8a Simplified schematic of a 2-cell Battery Cell Converter with stacked battery cells

FIG. 9 An example of a two-phase Battery Cell Converter with multiple parallel-connected cells, with local cell redundancy and with global cell redundancy

FIG. 9a An example of a two-phase Battery Cell Converter using a single cell coupled to two DC/DC converters or a two-phase DC/DC converter

FIG. 9b An example of a two-phase Battery Cell Converter with a set of coupled inductors, each coupled to a dedicated phase of a two-phase DC/DC converter

FIG. 10 Battery Cell Converter system with redundancy

FIG. 11 Stacking Battery Cell Converters

FIG. 12 Stacking Battery Cell Converters with monitor, control unit

FIG. 12a Stacking Battery Cell Converters with local & central monitor control units

FIG. 13 Charging individual battery cells in Battery Cell Converter stacks

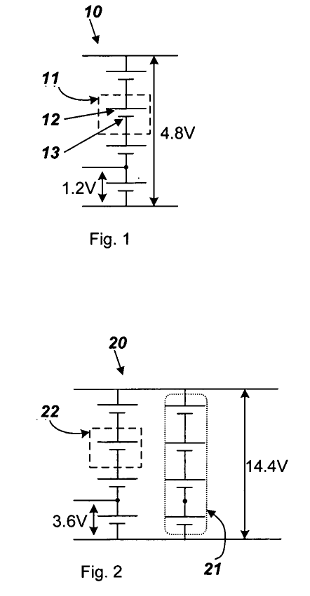

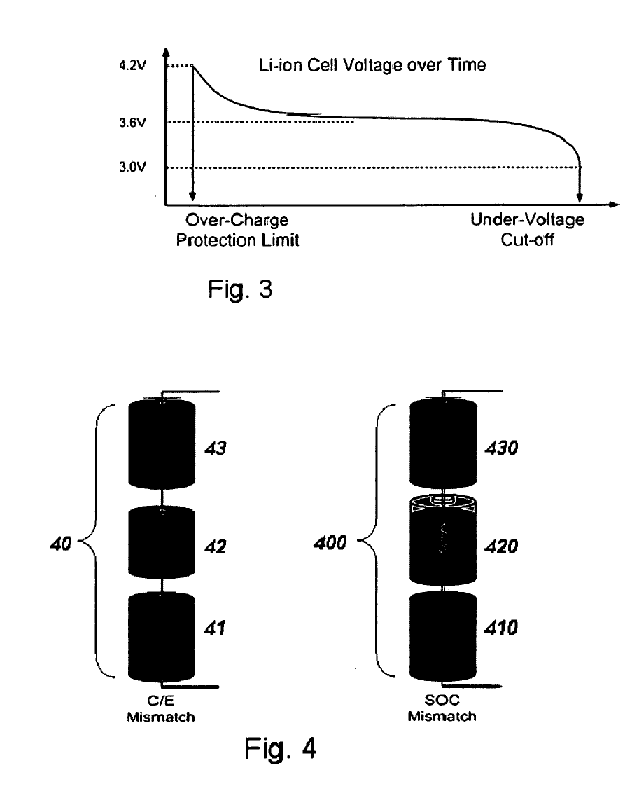

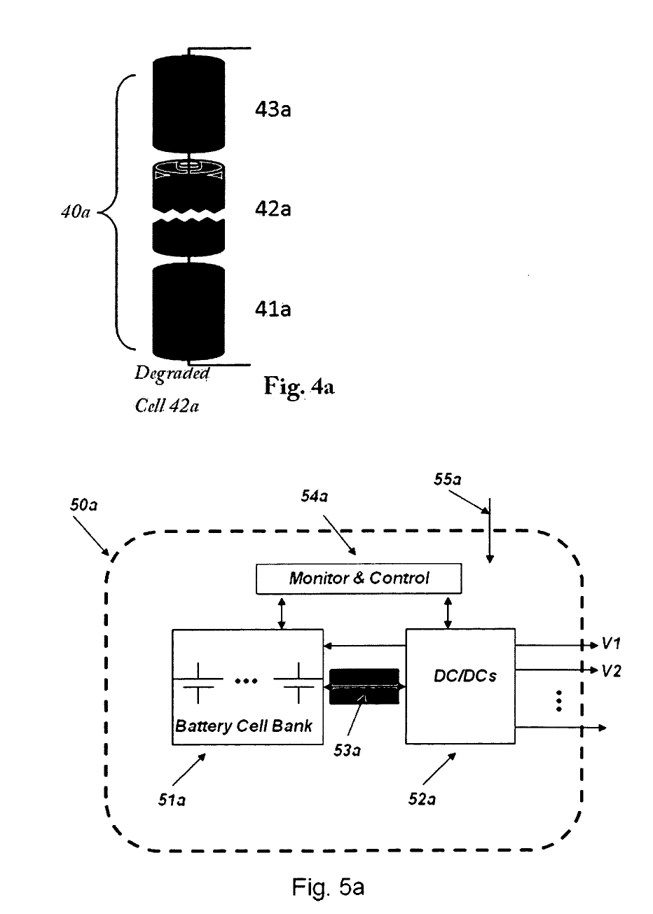

### DETAILED DESCRIPTION OF THE PREFERRED EMBODIMENTS

Disclosed herein in exemplary embodiments are a series of new system configurations and new methodologies which include the coupling of one or more DC/DC converters to one or more battery cells. These system configurations, herein referred to as Battery Cell Converters (BCC), provide a near constant voltage output or near constant multiple voltage outputs; the system topologies and algorithms also optimize the usage and reliability of individual battery cell as well as the battery pack system as a whole.

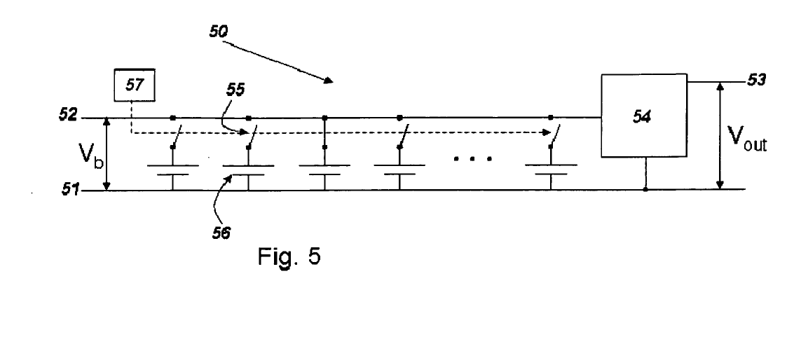

A block diagram of a multi-cell BCC system is shown in FIG. 5a. BCC unit 50a comprising one or more energy-storing battery cells 51a, one or more DC/DC converters 52a each having input and output terminals; terminals of the energy-storing battery cells are coupled to or integrate with input terminals of one or more of said DC/DC converters via 53a; There are one or more BCC system outputs (V1, V2, . . . ), which are also outputs of DC/DC converters; and a monitoring & control unit 54a. An external charging source 55a is used to charge BCC unit 50a. To charge the BBC system unit, an example is: as the monitor and control unit detects the presence of active external charging source, the DC/DC converter inputs will then be switched over to the incoming external charging source. So the DC?DC converter (or the BCC) outputs continue to be available. In the mean time, part of the incoming energy from the external source will be diverted to charge each of the battery cells by the monitor & control unit.

FIG. 5 shows one of the system configurations of multi-cell BCC unit 50. Battery cells 56 are connected to rails 51 and 52 through switches 55 (a “cell” is considered a single cell or a group of battery cells directly connected in parallel). Note that switches 35 can be in series with battery cells 56 connecting to the low-voltage rail or can be in series with battery cells 56 connecting to the high-voltage rails; connection to high-voltage rail 52 is depicted in FIG. 5. The switches are controlled by a control unit 57, which is symbolically depicted by a dashed arrow in FIG. 5. In FIG. 5, only one switch is closed while other switches are opened. In alternative implementations more than one switch can be closed at the same time. The on/off switching mechanisms are controlled by the BCC control algorithm applicable to specific applications or by a load-dependent adaptive algorithm. The voltage Vb across the battery cells can vary from cell to cell, and can vary with the state of discharge of each battery cell. The DC/DC converter 34 converts voltage Vb to a programmable, pre-determined voltage Vout, thus providing a near constant output voltage of the multi-cell battery converter unit 50. Vout can be larger or smaller than Vb. For the Battery Cell Converter configuration as shown in FIG. 5, there are numerous possible operating modes as determined by the switching sequencing control algorithm of switches 55.

For example,
a) One cell 56 connects at a time: the voltage Vb is monitored by control unit 57 and when the cell voltage drops below a pre-determined threshold, the connected cell 56 will then be considered as “discharged” by control unit 57. Then the corresponding switch 55 opens, while another switch then connects a “non-discharged” cell to rail 52;
b) Switch 55 associated with each battery cell is turned on in a sequential round-robin configuration. One possible arrangement is that each of the switches 55 is sequentially turned on per switching cycle. Voltage Vb of each cell 56 is monitored, and when the cell voltage drops below a pre-determined threshold, the connected cell 56 will then be considered as “discharged” by control unit 57. The corresponding switch 55 opens and disconnects the “discharged” cell till the battery is charged again. With one or more of the “discharged” cells disconnected, the remaining cells continued to be switched on and off sequentially till each of them is “discharged” or until the battery is charged again.
c) Switch 55 associated with each battery cell is turned on in accordance and proportional to the SOC of the cell. This helps to equalize the SOC among the various cells during discharge.
Note the versatility and flexibilities of the switching arrangements. Different switching algorithms can be used to optimize different application scenarios and objectives.

It is important to highlight that the relationship between cell terminal voltage and SOC is a function of cell current and operating temperature. Cell SOC can be inferred by cell terminal voltage with certain correction factors depending on cell current and temperature. Alternatively, SOC can be measured using “coulomb counting”, by measuring the cell current and integrating with time. The monitor, control and charging management unit can apply various methods to measure and to assess the cell SOC.

For purposes of illustration, some descriptions herein are based on simplified DC/DC converter schematics and with specific switching sequence controls waveforms. Based on the disclosure and teachings provided herein, it is obvious to anyone skilled in the art that there are many possible dc/dc switching topologies and switching sequence options that will provide various system benefits. The new concept of combining battery cells and power converters will enable improvements in battery pack usage efficiencies will increase battery pack useable time per charge, will extend battery pack life-time and will lower battery pack manufacturing cost.

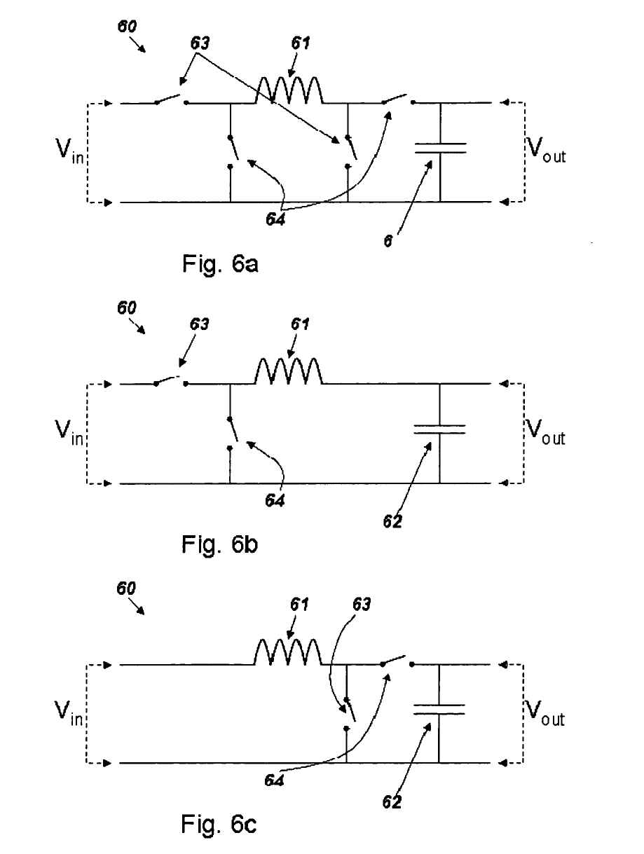

An example step-up/step-down DC/DC converter 60 is shown in FIG. 6a. A DC/DC converter includes inductor 61, capacitor 62, connecting switches 63 and equalizing switches 64. Switches 63 and 64 operate using non-overlapping clocks, while the duty cycle of such clocks determines the ratio of output voltage Vout to input voltage Vin. A detailed operation of DC/DC converter of FIG. 6a as well as other converters can be found in power electronics textbooks such as “Fundamentals of Power Electronics” by Robert W. Erickson and Dragan Maksimovic. A step-down DC/DC converter is shown in FIG. 6b, and a step-up DC/DC converter is shown in FIG. 6c, both are which similar to the converter of FIG. 6a. It will be clear to anyone skilled in the art that the present invention may use all types of DC/DC converters from FIGS. 6a-c, with the understanding that the step-down converter can only have output voltage smaller or equal to the input voltage, while step-up converter can only have output voltage larger or equal to the input voltage. A unique characteristic of BCC is that the switches that coupled between the battery cells and the dc/dc converter can serve dual functions as they are used to connect and disconnect the battery cells and also as part of the DC/DC converter. In other words, the DC/DC converter and the switching of the battery cells are integrated into one building block. In addition, a BCC unit can be generalized to have one or multiple battery cells coupled with one or multiple DC/DC converters with one or multiple voltage outputs.

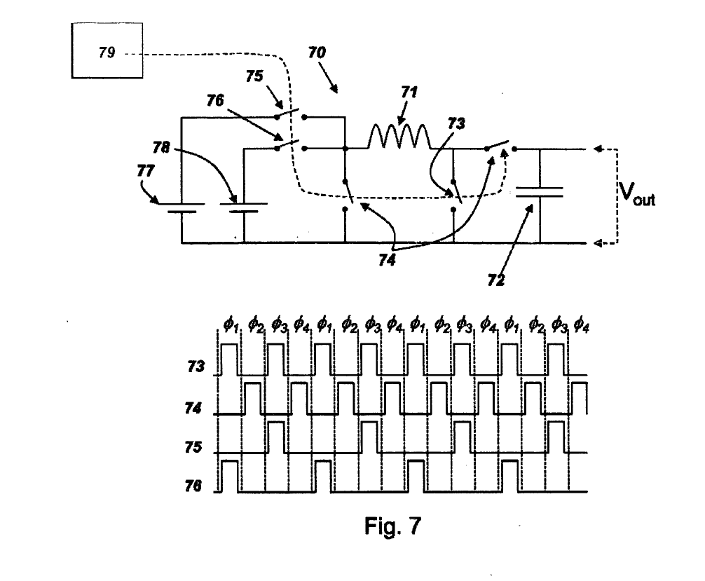

As mentioned previously in this disclosure, the switching sequence of switches coupled between the battery cells and the dc/dc converter is largely flexible. Applying this flexibility, one method of sharing a DC/DC converter in a BCC unit is shown in FIG. 7, which displays a system 70 having inductor 71 and capacitor 72. FIG. 7 shows an example of system 70 which shares a DC/DC converter comprising inductor 71, capacitor 72 and switches 73, 74, 75, 76. The DC/DC converter is shared between two battery cells 77 and 78. The switch control unit 79 ensures switches are properly operated thus ensuring desired output voltage Vout. In one example shown in FIG. 7, switches 73-76 are operated in four clock-phase sequences, with switch 74 high every other clock-phase sequence. The clock waveforms as shown in FIG. 7 correspond to up-converter switching sequences. It is clear to anyone skilled in the art that the switches can operate in other clock-phasing arrangements such as to operate the power converter as a step-down converter or having other clock-phase sequences. Note that the clock-phase 75/73 high followed by 74-high utilizes extraction of charge from the battery cell 77, and the sequence 76/73 high followed by 74 high utilizes extraction of charge from the battery cell 78. Alternatively, switches 75 & 76 can be combined to use the same clock 73. In another example of present invention, control unit 79 can measure the SOC of the two batteries and make a decision as to which battery's charge is to be extracted to the output. For example, if battery cell 77 has SOC smaller than that of battery cell 78, then the control unit will extract charge from battery cell 78 by providing 76/73 high followed by 74 high in consecutive clock sequences, without asserting 75/73 high. Then SOC of battery cell 78 will decrease until it becomes essentially equal to that of battery cell 77, upon which the control unit 79 extracts charge from the two battery cells alternatively. Therefore, this method ensures that the battery cells are discharged more uniformly, and no one battery cell has SOC substantially smaller than the rest in the pack. The capability of uniform cell discharge is important is because the battery cell life can be prolonged by charging the battery cell often and avoiding full-discharge cycles for certain rechargeable batteries such as Lithium Ion batteries. In addition, the switching algorithms used in conjunction with switching of DC/DC converter switching eliminates the need for separate, specific external components and the specific procedure of cell balancing during discharge.

Based on the disclosure and teachings provided herein, it is clear to anyone in the art that the discussion of system 70 can be generalized to the case of more than two battery cells. Moreover, a discussion of system 70 can also be generalized in case if battery cells 77 and or 78 comprise more than one battery cell connected in series.

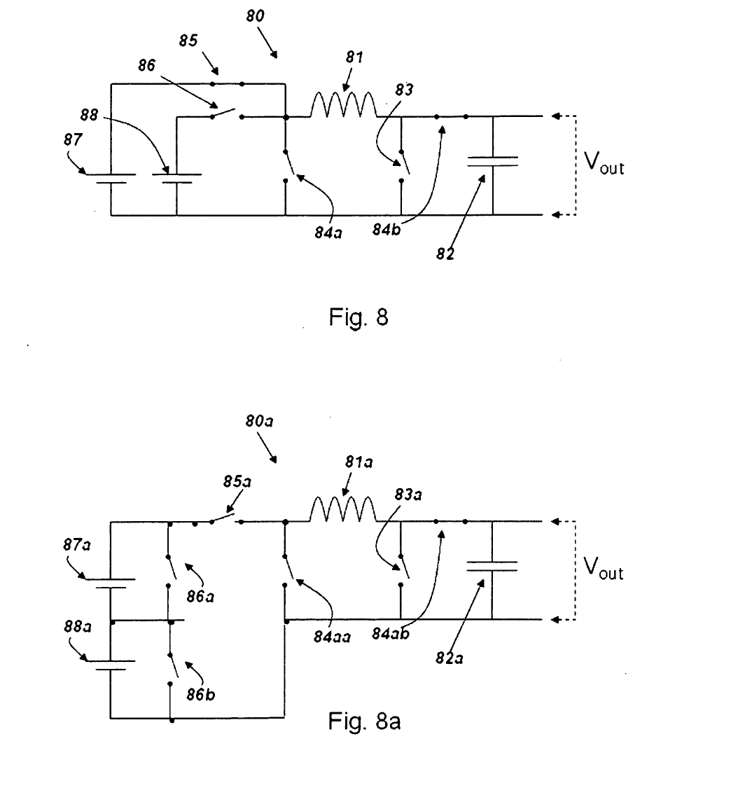

Charging of Battery Cell Converter unit can also be done safely, as shown in FIG. 8, which depicts a multi-cell battery unit 80 comprising inductor 81, capacitor 82, switches 83, 84a/b, 85, 86, and battery cells 87, 88. This is so because each of battery cells 87, 88 is not connected in series with any other cell and hence can each be imposed with an accurate voltage in the CV charging mode at the final charging stage. Therefore, the BCC topology eliminates the need of specific on-chip and off-chip components as well as the specific procedures for cell balancing during the charging process.

Another BBC configuration is using a more conventional stacked battery cell topology, except a normally opened switch is put in parallel to a battery cell. FIG. 8a shows an example of a 2-stacked-cell BCC. The positive terminal of cell 87a is coupled to DC/DC converter input through switch 85a. Switches 86a and 86b are connected in parallel to cell 87a and 88a respectively. The corresponding parallel switch will be closed (shorting the positive and negative cell terminals) in case one of the 2 stacked cells has degraded substantially. For example, if cell 87a is degraded and can no longer be charged properly. Then the monitor and control unit (not shown in FIG. 8a) will turn on 86a. Since the battery cell is coupled to the DC/DC converter, the output of BCC remains at the desired Vout value. As one can see, this approach can extend the practical life-time of a multi-cell battery pack; and the BCC architecture provides the desired output voltage even as each cell ages. This characteristic eliminates the need for the electronics powered by the output(s) of BCC units to tolerate large variations of supply voltages hence ease the electrical requirements. When compared to other parallel connected cell topologies, the cell-stacking configuration will face the usual undesirable characteristics relating to cell mismatch issues and would require additional circuitries to allow cell balancing during charge and discharge cycles.

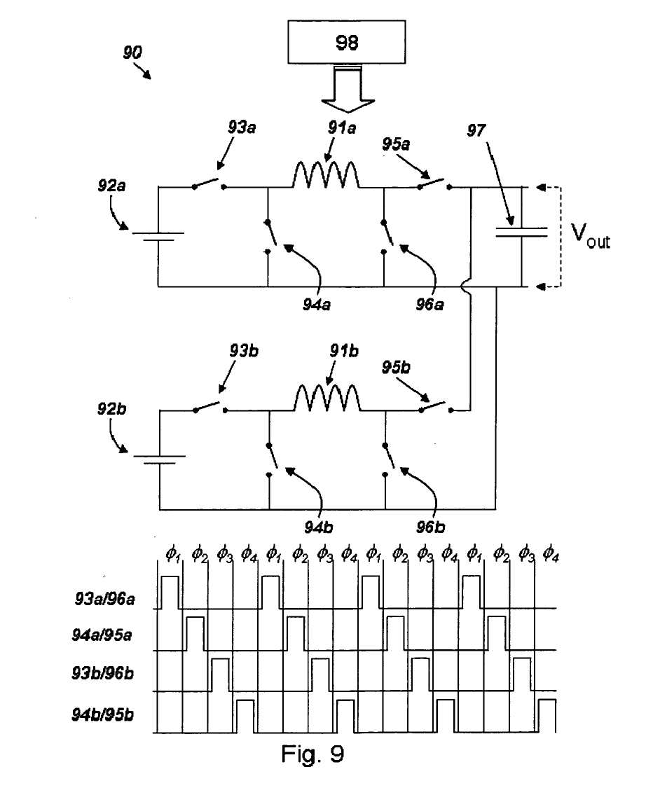

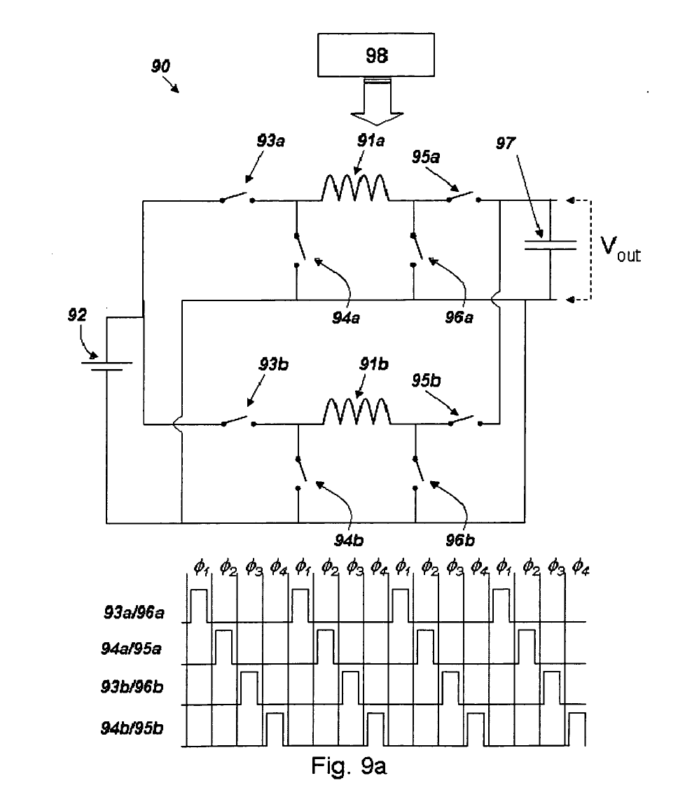

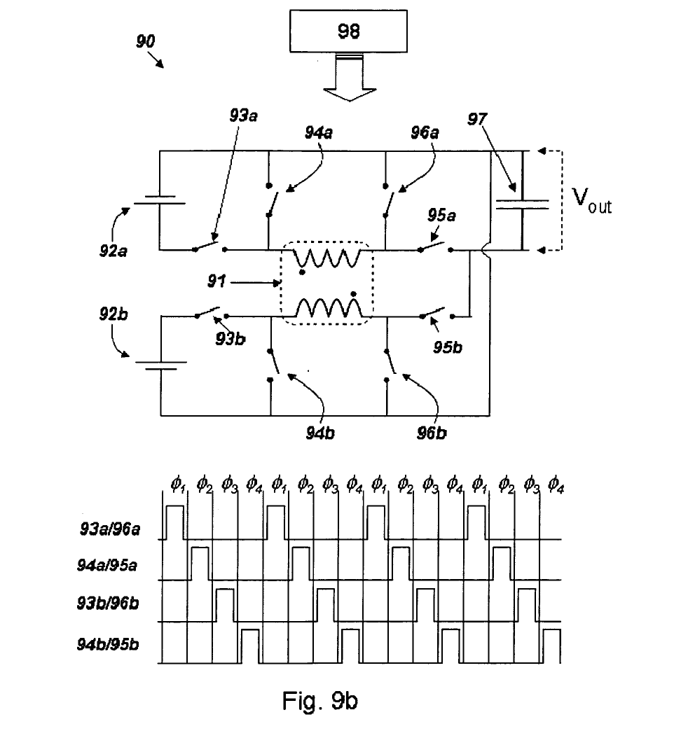

FIG. 9 depicts a two-phase BCC system 90. The system 90 includes two DC/DC converters or a single 2-phase converter having respectively inductors 91a and 91b, battery cells 92a and 92b, switches 93a and 93b, 94a and 94b, 95a and 95b, 96a and 96b, a common shared capacitor 97 coupled to the output of the BCC system 90, and a multi-phase control unit 98. The multi-phase control unit 98 controls phases of clocks of the switches to ensure that the system operates in correct 2-phase cycles. The fact that unit 98 controls the switch operation in BCC system 90 is symbolically shown by an arrow. The exemplary switch clocking diagram is also depicted in FIG. 9, with the understanding that the switch is in “short” state when its clock is high and in “open” state when its clock is low. A variation of a two-phase BCC system 90 is shown in FIG. 9a, where the 2-phase DC/DC converter is coupled to the same battery cell 92. And another variation of a two-phase BCC system 90 is shown in FIG. 9b. Here in comparison with FIG. 9, the two separate inductors are replaced by a coupled inductor unit 91, which allows a more efficient DC/DC converter operation with faster startup time. Note that simple generalizations can be made to the exemplary embodiments of FIGS. 9/9a/9b. For example, a shared battery could also be used in a coupled inductor system. A two-phase system can also be generalized to a BCC system with any number of phases, with additional hardware relating to the implementation of multi-phase DC/DC converter(s).

A multi-phase BCC system also provides additional battery life extension flexibility and capability. For example, in case one of the battery cells in a 4-phase BCC system became defective, the system control unit will know about it and disconnect the defective cell from the system if the cells are connected in the parallel mode. Or alternatively, the control unit can reconfigure the 4-phase system into a 3-phase system if the cells are connected uniquely to each of the input of each phase of the power converter. Hence, one can see the ability of the BCC system to allow battery packs to continue to operate even with some of the cells became defective.

In addition, switching algorithms are used to support load-dependent & SOC-dependent adaptive auto-configure multi-cell, multi-phase BCC system. This enables the system to optimize system power consumptions and further enhance the ability to extend battery pack per-charge use-time.

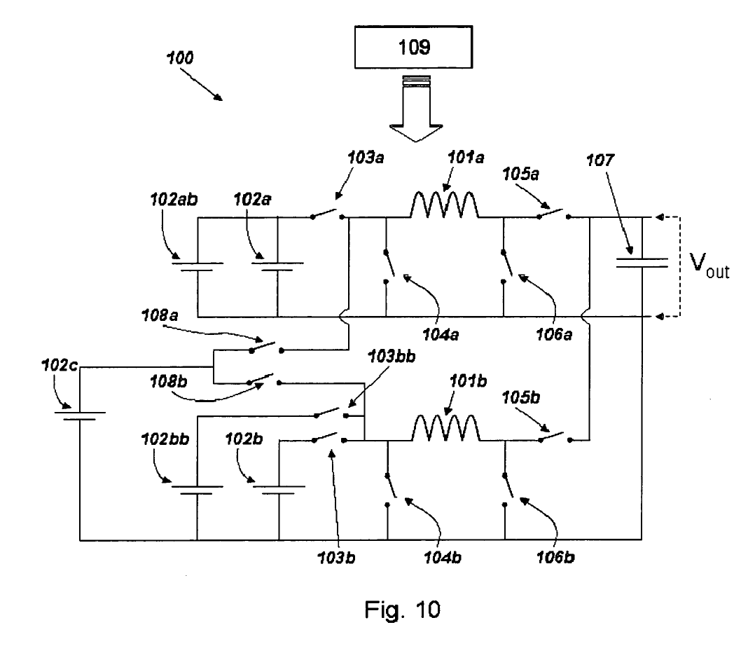

FIG. 10 shows examples that illustrate the different types of charge cell redundancy in a 2-phase BCC system 100. Cells 102a and 102ab are simultaneously coupled to DC/DC converter which include inductor 101a, switches 103a, 104a, 105a, and 106a which delivers charge to output capacitor 107. Connecting cell 102ab in parallel with the cell 102a reduces the rate of discharge of cell 102a during operation. Local redundancy is depicted in the cells coupled to the second or second-phase of DC/DC converter including inductor 101b, switches 103b, 103bb, 104b, 105b and 106b, delivering charge to the output capacitor 107. The battery cells 102b and 102bb are coupled to separate switches 103b and 103bb, and therefore can be operated one-at-a-time (unlike cells 102a and 102ab that are connected “directly” in parallel). For example, if battery cell 102b runs out of charge, cell 102bb can be used in further operation so that the BCC system still functions. Alternatively, switches 103b and 103bb can be time-multiplexed thereby allowing charges to be drawn from cells 102b and 102bb respectively based on duty-cycled clocking sequence. Since it is clear that the battery cell 102bb can only “help” cell 102b, but not cells 102a/102ab; hence the name “local” redundancy is used. Finally, battery cell 102c coupled to switches 108a and 108b provides global redundancy, because it can replace any battery cell in the pack, in case when that particular cell fails. A multi-phase clock and redundancy control unit 109 controls the clocks of the two-phase BCC system 100 to ensure operation already described in conjunction with FIGS. 9/9a/9b. In addition, it controls redundancy cell connection, i.e. it decides which switch 103b, 103bb, or 108b is to be closed when charge is delivered to inductor 101b, and which switch among 103a and 108a is to be closed when charge is delivered to inductor 101a. In one exemplary embodiment, the clock and redundancy control unit monitors the SOC of battery cells by monitoring voltage output, charge fuel gauging, and controls operation of related switches in a way that the strongest cells deliver charge first, i.e. the equivalent SOC discharging rate of the cells is equalized. It is clear to anyone skilled in the art that the parallel cell connection, local redundancy and global redundancy concepts and redundancy control can be applied to BCC systems working with multi-phase operation, having shared battery cells, and/or having coupled inductors, as described in conjunctions with FIGS. 9/9a/9b.

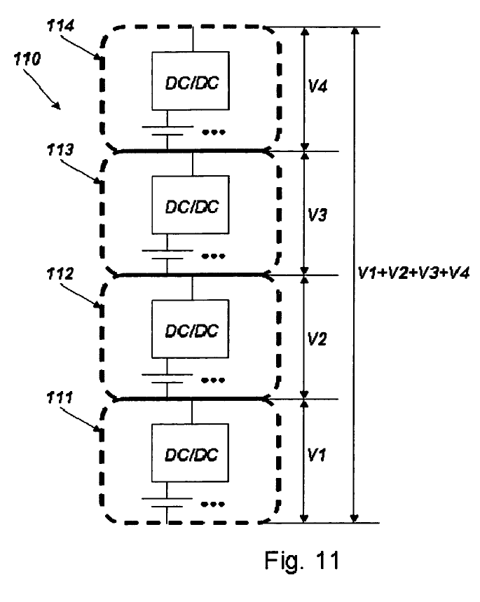

If high output voltage such as 48V or higher is desired, convention solution will simply be stacking a series of battery cells. As the number of series-connected cells increased, it is obvious that the problems relating to cell mismatch during charging and discharging will be amplified dramatically. That is, if one cell turns bad, the entire series-stacked cell chain will become defective. A stacked BCC structure will eliminate many of those undesirable characteristics in the conventional approach (this will be further discussed later in this document). A stacked BCC approach is desirable over simply using DC/DC converters to multiply up the output voltage because DC/DC converter efficiency degrades for large converting ratios. For example, for converter ratio of no more than two, it is practical to achieve efficiency of ˜95%. However, if the converting ratio increases to ten, efficiency would probably degrade to 80% or less. FIG. 11 shows a BCC unit 110 that includes four stacked BCC sub-units 111-114, each having constant output voltage V1-V4 Volts respectively. The numbers V1, . . . , V4 are not necessarily equal to each other. It is clear that the output voltage of a BCC system is V1+V2+V3+V4. Moreover, if charge of all cells in a particular BCC sub-unit is prematurely exhausted (say, sub-unit 112), it can simply be bypassed by a parallel switch while remaining V1, V3, V4 can be adjusted so that V1+V3+V4 is equal to the original pre-determined value. A side benefit of employing stacked BCC topology is that one does not need a very high voltage silicon process to support a high voltage output. This broadens the possible selections of process technologies and enables the design of highly integrated and efficient power converters.

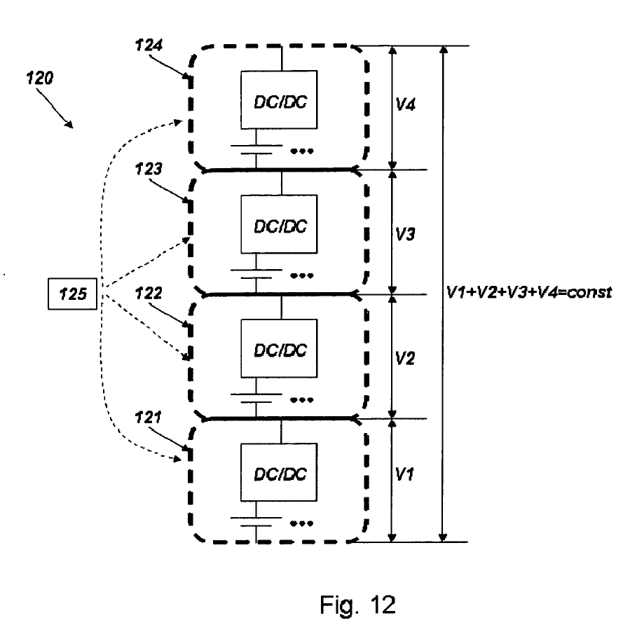

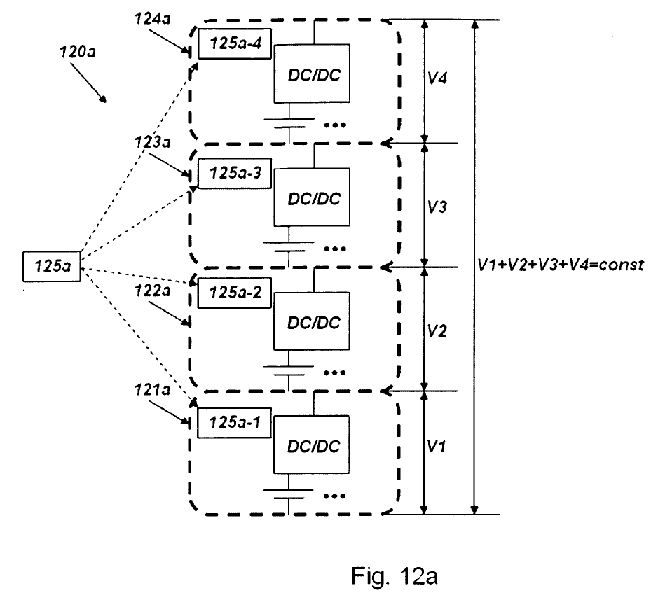

FIG. 12 shows another embodiment of BCC unit 120 which includes four stacked BCC sub-units 121-124 each having output voltage V1-V4 respectively. A control unit 125 controls voltages V1-V4 by controlling settings of DC/DC converters in 121-124. By measuring SOC of operational battery cells within units 121-124, control unit 125 adjusts output voltages so that the output voltage is set to be proportional to the SOC of the BCC unit. Yet, the sum V1+V2+V3+V4 can be controlled to remain constant. Such action reduces power drainage on the weakest battery cell and prolongs the lifetime of the whole stacked cell battery system 120. Moreover, pulsing switches in DC/DC converters produces spurious noise at the output of the multi-cell battery unit. In stacked cells, the voltage noise adds linearly.

FIG. 12a shows that each stacked BBC unit 121a-124a has its own local monitor, and control & charge management units 125a-1, 125a-2, 125a-3 and 125a-4 respectively. Units 125a-1 to 125a-4 are connected to a centralized controller 125a. Note that with proper definition of the interface signaling; only the controller 125a may need to be able to support high voltage. This architecture allows the design of the stacked BCC units to be modular based and able to communicate to the main controller 125a.

For stacked BCC architecture as shown in FIGS. 12 & 12a, it is possible to run the DC/DC converters at each stack at different phases, with phase synchronization between the controllers at each stacked level, one can achieve an equivalent of a multiphase converter solution to the final stacked output.

Based on the disclosure and teachings provided herein, it is clear to anyone skilled in the art that the discussion of FIGS. 11, 12 and 12a can be generalized to any number of stacked BCC sub-units.

In another embodiment, control unit 125 or 125a misaligns or dithers pulse phases of each individual DC/DC converter in the stack, in order to spread the output voltage noise of the whole stack to higher frequencies.

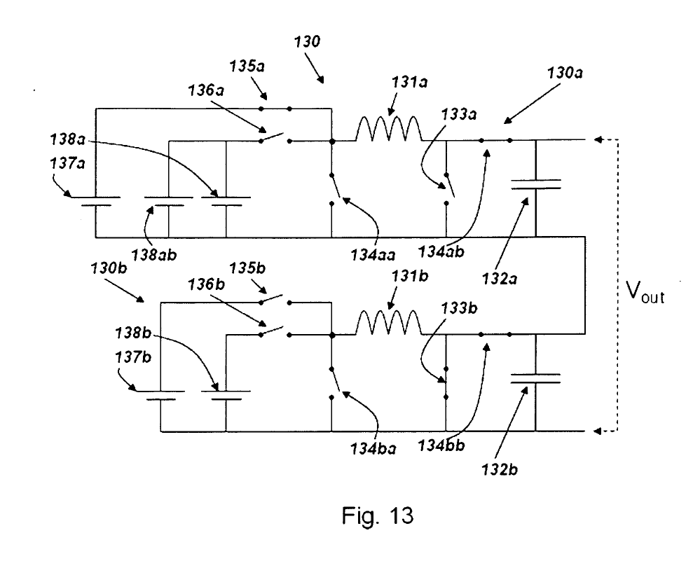

As previously mentioned, a stacked BCC topology of multi- or single-cell units ease the challenges of charging and discharging battery cells as described in this document. It is because each of the cells in the stacked BCC structure can still be charged independently. An example is shown in FIG. 13. A BCC system 130 includes two stacked BCC sub-units, with DC/DC converter-coupled multi-cell batteries 130a and 130b, each correspondingly having inductors 131a,b, capacitors 132a, 132b, switches 133a, 133b, 134aa, 134ab, 134ba, 134bb, 135a, 135b, 136a, 136b, and battery cells 137a, 137b and 138a, 138ab, 138b. The charging mechanism of each of the stacked BBC unit is similar to that of the un-stacked BCC units as described earlier in this disclosure. It is clear to any persons skilled in the art that the individual charging of battery cells can be generalized to any number of stacked BCC units, each unit having an arbitrary appropriate number of battery cells.

What is claimed is:

1. A Battery Cell Converter system comprising:
one or more energy-storing battery cells each having high and low voltage terminals; and
one or more DC/DC converters each having input and output terminals;
wherein high and low-voltage terminals of each of said energy-storing battery cells is coupled to or integrate with input terminals of one or more of said DC/DC converters; and
wherein the output terminals of each DC/DC converter constitute an output of the Battery Cell Converter system.
a monitoring & control unit which comprising one or more of the following functions:
a) measures voltage across each single battery cell or each group of direct parallel-connected battery cells
b) fuel gauging and monitoring of the State of Charge of each single battery cell or each groups of battery cells
c) control the charging circuits to charge
i. each of the single battery cell or each group of direct parallel-connected battery cells, or
ii. all of the battery cells as a group.

2. A Battery Cell Converter system of claim 1, wherein each cell or each group of direct parallel-connected energy-storing battery cells is coupled to one or more of the DC/DC converters via one or more switches

3. A Battery Cell Converter system of claim 1, wherein each cell or each group of direct parallel-connected energy-storing battery cells is coupled to a corresponding DC/DC converter via dedicated switches.

4. A Battery Cell Converter system of claim 1, wherein the energy-storing battery cells are charged by charging circuits while the DC/DC converters are delivering output voltages and/or currents to loads.

5. A Battery Cell Converter system of claim 1, wherein each cell or each group of direct parallel-connected energy-storing battery cells is disconnected from other cells by turning off one or more switches connected in series with the battery cells.

6. A Battery Cell Converter system of claim 1, wherein each cell or each group of direct parallel-connected energy-storing battery cells is not stacked with another cell in series connection.

7. A Battery Cell Converter system of claim 1, further comprising a monitoring & control unit which controls the coupling between the DC/DC converters and the energy-storing cells or turning on/off of coupling switches between the cells and the DC/DC converters.

8. A Battery Cell Converter system of claim 7, wherein the monitoring & control unit controls an access sequence and a length of access time in which the DC/DC converters coupled to the corresponding most-charged energy-storing cells.

9. A Battery Cell Converter system of claim 1, wherein the DC/DC converters are either single or multi-phase converters

10. A Battery Cell Converter system of claim 9, wherein the monitor & control unit controls & defines the phase relationships, on/off duty cycles of each phase of the multi-phase DC/DC converters.

11. A Battery Cell Converter system of claim 9, the input of the multi-phase converters is coupled to the entire bank of battery cells at a common set of terminals or each converter phase is coupled to dedicated banks of battery cells in parallel respectively

12. A Battery Cell Converter system of claim 9, the monitor and control unit alters the corresponding phase controls, duty cycles, or reconfiguration of the number of DC/DC converter phases such as from a 4-phase converter system to a 3-phase converter system.

13. A Battery Cell Converter system of claim 12, the monitor and control unit alters the corresponding phase controls, duty cycles, or reconfiguration of the number of DC/DC converter phases such as from a 4-phase converter system to a 3-phase converter system in response to the healthiness of battery cells within the system.

14. A Stacked Battery Cell Converter system comprising:
A set of Battery Cell Converter sub-systems of claim 1,
Wherein the Battery Cell Converter sub-systems are stacked in series, so that the output voltage of the overall system is equal the sum of output voltages of respective sub-systems in a stack

15. A Stacked Battery Cell Converter system of claim 14, further comprising a voltage control unit that sets the output voltage value of each of the sub-systems and so that the sum of the set values is equal to the desired output value for the Stacked Battery Cell Converter system.

16. A Stacked Battery Cell Converter system of claim 15, wherein the voltage control unit further monitors the State-Of-Charge of energy-storing cells within each sub-units, and sets output voltage values for each of the BCC sub-systems to be proportional to the State-Of-Charge of the cells in each of the sub-systems, while the sum of output voltage values of all sub-systems is equal to the desired output value for the overall Stacked Battery Cell Converter system.

17. A Stacked Battery Cell Converter system of claim 16, each of the stacked BCC sub-system further comprising a communication connection channel between local monitor & control units of each of the BCC sub-systems.

18. A Stacked Battery Cell Converter system of claim 16, each of the stacked BCC sub-system further comprising a communication connections channel between local monitor & control unit and a master system control unit

19. A Stacked Battery Cell Converter system of claim 18, wherein the overall system control unit sets output voltage values for each of the sub-systems to be proportional to the State-Of-Charge of the cells in each of the BCC sub-systems, while the sum of output voltage values of all sub-systems is equal to the desired output value for the overall Stacked Battery Cell Converter system.

20. A Stacked Battery Cell Converter system of claim 16, wherein the DC/DC converter switching phase of each of the BCC sub-systems is synchronized with controlled phase-relationships.

21. A method of extending battery cell life-time in the BCC system of claim 2, comprising:
Minimizing any single battery cell within a BCC system be exposed to over discharge by controlling the duty cycle at which the battery cells are accessed to be proportional to cell SOC during discharge cycles
Minimizing any single battery cell within a Stacked-BCC system be exposed to over discharge by controlling the output voltage of each of the Stacked-BCC sub-systems to be proportional to cell SOC during discharge cycles

22. A method of extending battery pack life-time in the BCC system of claim 2, comprising:
Connecting two or more energy storing battery cells in parallel
Disconnecting a substantially degraded cell by turning off a switch connected in series to a battery cell
coupling the top and bottom terminals of series connected stacked battery cells to input terminals of DC/DC converter to provide desired BBC output voltage

23. A Battery Cell Converter system of claim 1, comprising:
two or more energy storing battery cells connected in series
a switch is connected in parallel to a battery cell to bypass the cell in case it is substantially degraded

24. A method of extending battery pack life-time in the BCC system of claim 23, comprising:
bypassing substantially degraded energy storing battery cell through a bypass-switch connected in parallel to the degraded cell
coupling the top and bottom terminals of series connected stacked battery cells to input terminals of DC/DC converter to provide desired BBC output voltage

25. A method of extending battery pack life-time of BCC system of claim 1, comprising:
adding redundancy battery cells with switches to substitute degraded cells
